(19) United States
(12) Patent Application Publication
(10) Pub. No.: US 2017/0282500 A1
(43) Pub. Date: Oct. 5, 2017

(54) GLASS LAMINATE, METHOD FOR PRODUCING ELECTRONIC DEVICE, METHOD FOR PRODUCING GLASS LAMINATE, AND GLASS PLATE PACKAGE

(71) Applicant: ASAHI GLASS COMPANY, LIMITED, Chiyoda-ku (JP)

(72) Inventors: Tatsuzo MIYAGOE, Tokyo (JP); Hideaki MIYAZAWA, Tokyo (JP); Shinjo MITANI, Tokyo (JP); Akira NAKAZAWA, Tokyo (JP); Keiichi KAWAKAMI, Tokyo (JP)

(73) Assignee: ASAHI GLASS COMPANY, LIMITED, Chiyoda-ku (JP)

(21) Appl. No.: 15/629,384

(22) Filed: Jun. 21, 2017

Related U.S. Application Data
(63) Continuation of application No. PCT/JP2015/085717, filed on Dec. 21, 2015.

(30) Foreign Application Priority Data
Dec. 26, 2014 (JP) 2014-265172
Nov. 2, 2015 (JP) 2015-215819

(51) Int. Cl. B32B 7/12; B32B 17/10

(52) U.S. Cl. CPC B32B 7/12; B32B 17/10036; B32B 17/10798; B32B 2457/20

(57) ABSTRACT

A glass laminate includes a support substrate, an adhesive layer and a glass substrate in this order. The glass laminate has a peel strength between the support substrate and the adhesive layer different from a peel strength between the adhesive layer and the glass substrate. The glass laminate has a contact area between the adhesive layer and the support substrate and a contact area between the adhesive layer and the glass substrate both being 1200 cm² or more. The glass substrate has a thickness of 0.3 mm or less. There are no bubbles or, when there is a bubble(s), the bubble(s) has a diameter of 10 mm or less, in a boundary between the support substrate and the adhesive layer or a boundary between the adhesive layer and the glass substrate, whichever has a smaller peel strength.

### TECHNICAL FIELD

The present invention relates to a glass laminate, a method for manufacturing an electronic device using the glass laminate, a method for manufacturing a glass laminate, and a glass sheet packaging.

### BACKGROUND ART

In recent years, devices (electronic devices) such as photovoltaic cells (PV), liquid crystal display (LCD) panels and organic EL display (OLED) panels are becoming thinner and lighter, and the glass substrates used for these devices are being made to be thinner. When the strength of the glass substrate is insufficient due to thinning, the handling property of the glass substrate is deteriorated in the device manufacturing steps.

Recently, in order to cope with the problem described above, a method has been proposed in which, a glass laminate in which a glass substrate and a reinforcing plate are laminated is prepared and a member for an electronic device such as a display device is formed on the glass substrate of the glass laminate, and thereafter the reinforcing plate is separated from the glass substrate (for example, PTL 1). The reinforcing plate has a support plate and a silicone resin layer fixed on the support plate, and the silicone resin layer and the glass substrate are peelably adhered to each other. A reinforcing plate where peeling has occurred at the interface between the silicone resin layer and the glass substrate of the glass laminate and which is separated from the glass substrate is able to be laminated with a new glass substrate and reused as a glass laminate.

### CITATION LIST

### Patent Literature

PTL 1: WO 2007/018028

### SUMMARY OF INVENTION

### Technical Problem

Meanwhile, in recent years, there has been a demand for yield improvements to further reduce the cost of electronic devices. Therefore, if the glass substrate is cracked when peeling off the glass substrate from the glass laminate after arranging the member for an electronic device on the glass substrate in the glass laminate under high temperature conditions, the yield of the electronic device is decreased, which is not preferable.

When the present inventors prepared a plurality of glass laminates and peeled off the glass substrates in accordance with the method described in PTL 1, it was confirmed that cracking occurred in a certain number of glass substrates and the recent demand level was not always met.

The present invention was made in view of the above problems and has an object of providing a glass laminate in which the occurrence of cracking in a glass substrate is suppressed to a greater extent when peeling off the glass substrate.

In addition, the present invention has another object of providing a method for manufacturing an electronic device using the glass laminate, a method for manufacturing a glass laminate, and a glass sheet packaging.

### Solution to Problem

As a result of intensive studies to solve the problems described above, the present inventors found that it is possible to obtain the desired effect by adjusting the presence or absence of bubbles or the size thereof in a boundary between a support substrate and an adhesive layer or a boundary between the adhesive layer and a glass substrate, whichever has a smaller peel strength, thereby completing the present invention.

That is, a first aspect of the present invention is a glass laminate including a support substrate, an adhesive layer and a glass substrate in this order, and having a peel strength between the support substrate and the adhesive layer different from a peel strength between the adhesive layer and the glass substrate, in which the glass laminate has a contact area between the adhesive layer and the support substrate and a contact area between the adhesive layer and the glass substrate both being 1200 cm² or more, the glass substrate has a thickness of 0.3 mm or less, and there are no bubbles or, when there is a bubble(s), the bubble(s) has a diameter of 10 mm or less, in a boundary between the support substrate and the adhesive layer or a boundary between the adhesive layer and the glass substrate, whichever has a smaller peel strength.

In the first aspect, the diameter of the bubble(s) is preferably 5 mm or less.

In the first aspect, the support substrate is preferably a glass sheet.

In the first aspect, the adhesive layer is preferably a silicone resin layer or a polyimide resin layer.

In the first aspect, the peel strength between the support substrate and the adhesive layer is preferably larger than the peel strength between the adhesive layer and the glass substrate.

A second aspect of the present invention is a method for manufacturing an electronic device, including a member forming step of forming a member for an electronic device on a surface of the glass substrate of the glass laminate according to the first aspect to obtain a laminate with an attached member for an electronic device, and a separation step of removing a support substrate with an attached adhesive layer including the support substrate and the adhesive layer from the laminate with an attached member for an electronic device to obtain an electronic device having the glass substrate and the member for an electronic device.

A third aspect of the present invention is a method for manufacturing the glass laminate according to the first aspect, in which a glass sheet in a glass sheet packaging, in which a plurality of glass sheets are laminated via a composite paper(s) made of a virgin pulp, is used as at least one of the support substrate and the glass substrate of the glass laminate to manufacture the glass laminate.

A fourth aspect of the present invention is a glass sheet packaging including a plurality of glass sheets laminated via a composite paper(s) made of a virgin pulp, and used for manufacturing a glass laminate including a support substrate, an adhesive layer and a glass substrate in this order.

### Advantageous Effects of Invention

According to the present invention, it is possible to provide a glass laminate in which occurrence of cracking in the glass substrate is suppressed to a greater extent when peeling off the glass substrate.

In addition, according to the present invention, it is also possible to provide a method for manufacturing an electronic device using a glass laminate, in which the occurrence of cracking in a glass substrate is suppressed to a greater extent, a method for manufacturing a glass laminate, and a glass sheet packaging.

### BRIEF DESCRIPTION OF DRAWINGS

FIG. 1 is a schematic cross-sectional view of a first embodiment of a glass laminate according to the present invention.

(A) of FIG. 2 to (D) of FIG. 2 are schematic cross-sectional views illustrating an embodiment of a method for manufacturing an electronic device according to the present invention in order of the steps.

FIG. 3 is a schematic cross-sectional view of a second embodiment of a glass laminate according to the present invention.

### DESCRIPTION OF EMBODIMENTS

A description will be given below of embodiments for carrying out the present invention with reference to the drawings; however, the present invention is not limited to these following embodiments, and various modifications and substitutions can be performed on the following embodiments within a range not departing from the scope of the present invention.

One of the features of the glass laminate of the present invention is a point of adjusting the presence or absence of bubbles or the size of bubbles in a boundary between the support substrate and the adhesive layer or a boundary between the adhesive layer and the glass substrate, whichever has a smaller peel strength.

The inventors of the present invention found that there is a relationship between the presence of bubbles and a cause of easy cracking of the glass substrate in the glass laminate described in PTL 1. A description will be given below, as an example, of a case of a glass laminate in which the peel strength between the support substrate and the adhesive layer is larger than the peel strength between the adhesive layer and the glass substrate; however, the present invention is not limited to the following example.

When manufacturing an electronic device by using such the glass laminate, at the time of peeling off the glass substrate after arranging the member for an electronic device on the glass substrate, the peeling proceeds between the adhesive layer and the glass substrate where the peel strength is lower. When peeling off the glass substrate, peeling from the adhesive layer is usually performed from one end side of the glass substrate. At that time, the glass substrate is peeled off while a peeling line, which is a boundary line between a portion where the adhesive layer and the glass substrate are not peeled off and a portion where the adhesive layer and the glass substrate are peeled off, moves in one direction. In a case where bubbles of a predetermined size are present between the adhesive layer and the glass substrate, when the peeling line reaches the first end portion of a bubble, the peeling line moves locally in that portion up to the side of the other end opposing the first end portion of the bubble and stress is concentrated locally in that portion on the glass substrate. As a result, cracking of the glass substrate is induced.

On the other hand, in the present invention, by eliminating bubbles between the adhesive layer and the glass substrate or, even in a case where bubbles are present, by setting the size of the bubbles to a predetermined value or less, large movements of the peeling line described above are prevented to suppresses the generation of local stress. As a result, the occurrence of cracking in the glass substrate is suppressed.

In addition, in the glass laminate as described above, expansion of the size of the bubbles substantially does not occur even when a heat treatment is applied to the glass laminate. On the other hand, in a case where bubbles having a size exceeding a predetermined value are present between the adhesive layer and the glass substrate, the expansion of the bubbles tends to occur during the heat treatment, and lifting of the glass substrate occurs easily. When such the lifting of the glass substrate occurs, collisions with a coater which coats various types of members on the glass laminate are likely to occur. However, such a problem does not easily occur in the glass laminate of the present invention.

In the glass laminate of the present invention, the peel strength between the support substrate and the adhesive layer (peel strength at the interface of the adhesive layer with respect to the layer of the support substrate) and the peel strength between the adhesive layer and the glass substrate (peel strength at the interface of the adhesive layer with respect to the layer of the glass substrate) are different.

Therefore, as a first embodiment, a detailed description will be given below of a glass laminate in which the peel strength at the interface of the adhesive layer with respect to the layer of the glass substrate is smaller than the peel strength at the interface of the adhesive layer with respect to the layer of the support substrate, peeling occurs between the adhesive layer and the layer of the glass substrate, and the laminate of the adhesive layer and the support substrate and the glass substrate are separated.

In addition, as a second embodiment, a detailed description will be given of a glass laminate in which the peel strength at the interface of the adhesive layer with respect to the layer of the glass substrate is larger than the peel strength at the interface of the adhesive layer with respect to the layer of the support substrate, peeling occurs between the adhesive layer and the layer of the support substrate, and the laminate of the glass substrate and the adhesive layer and the support substrate are separated.

As will be described below in detail, in the first embodiment (in a case where the peel strength between the support substrate and the adhesive layer is larger than the peel strength between the adhesive layer and the glass substrate), the presence or absence of bubbles and the size of bubbles are controlled between the adhesive layer and the glass substrate and, in the second embodiment (in a case where the peel strength between the adhesive layer and the glass substrate is larger than the peel strength between the support substrate and the adhesive layer), they are controlled between the support substrate and the adhesive layer.

First, the detailed description will be given below of the first embodiment and then the detailed description will be given of the second embodiment.

### First Embodiment

First, the detailed description will be given below of one embodiment (first embodiment) of the glass laminate according to the present invention.

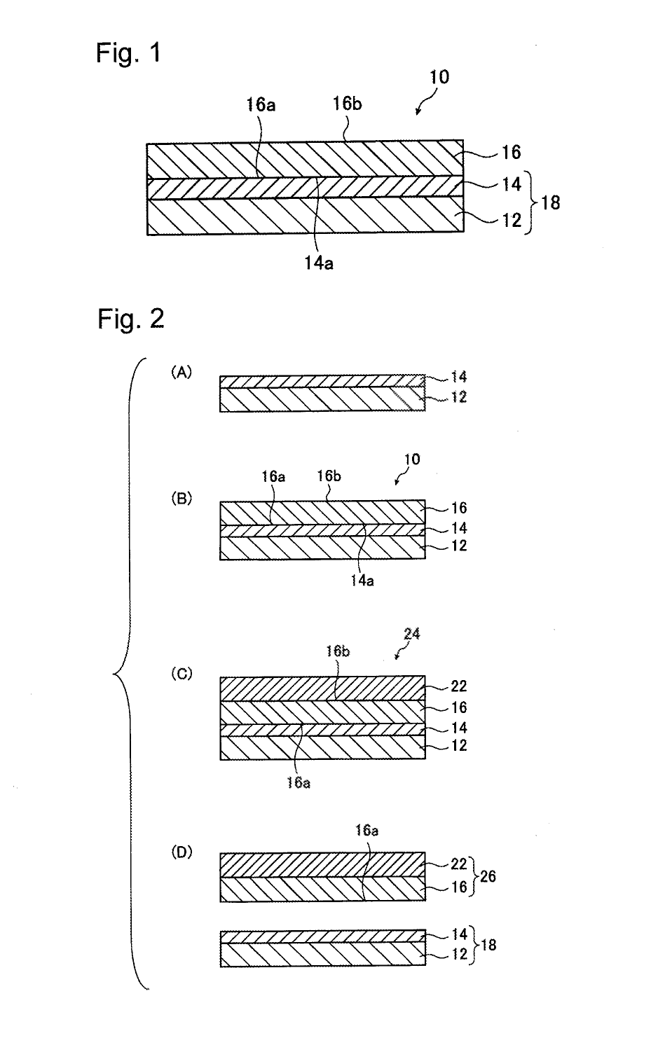

FIG. 1 is a schematic cross-sectional view of an example of the glass laminate according to the present invention.

As illustrated in FIG. 1, a glass laminate 10 is a laminate which includes a layer of a support substrate 12, a layer of a glass substrate 16 and an adhesive layer 14 present between these layers. One surface of the adhesive layer 14 is in contact with the layer of the support substrate 12 and the other surface thereof is in contact with a first main surface 16a of the glass substrate 16. The two-layer portion formed of the layer of the support substrate 12 and the adhesive layer 14 reinforces the glass substrate 16 in a member forming step of manufacturing a member for an electronic device such as a liquid crystal panel.

The glass laminate 10 is used up to a member forming step to be described below. That is, the glass laminate 10 is used until a member for an electronic device such as a liquid crystal display device is arranged on the surface of a second main surface 16b of the glass substrate 16. Thereafter, the glass laminate on which the member for an electronic device has been arranged is separated into a support substrate 18 with an attached adhesive layer and a glass substrate with an attached member, and the support substrate 18 with an attached adhesive layer is not a portion constituting the electronic device. A new glass substrate 16 is laminated on the support substrate 18 with an attached adhesive layer and the resultant is able to be reused as a new glass laminate 10.

Here, in the glass laminate 10 of FIG. 1, the adhesive layer 14 is fixed on the support substrate 12, and the glass substrate 16 is peelably laminated (adhered) on the adhesive layer 14 of the support substrate 18 with an attached adhesive layer. In the present invention, fixing and peelably laminating (adhering) differ in peel strength (that is, the stress required for peeling) and the fixing means that the peel strength is larger than that in the adhering. In other words, the peel strength between (at the interface of) the adhesive layer 14 and the support substrate 12 is larger than the peel strength between (at the interface of) the adhesive layer 14 and the glass substrate 16. That is to say that the peelable lamination (adhesion) means that peeling is possible and also that the peeling is possible without causing a peeling at the fixed surface.

More specifically, the interface between the support substrate 12 and the adhesive layer 14 has a peel strength (x) and when stress is applied in the peeling direction exceeding the peel strength (x) at the interface between the support substrate 12 and the adhesive layer 14, peeling occurs at the interface between the support substrate 12 and the adhesive layer 14. The interface between the adhesive layer 14 and the glass substrate 16 has a peel strength (y) and when stress is applied in the peeling direction exceeding the peel strength (y) to the interface between the adhesive layer 14 and the glass substrate 16, peeling occurs at the interface between the adhesive layer 14 and the glass substrate 16.

In the glass laminate 10 (also meaning a laminate with an attached member for an electronic device described below), the peel strength (x) is larger than the peel strength (y). Accordingly, when a stress is applied to the glass laminate 10 in the direction for peeling the support substrate 12 and the glass substrate 16 apart, the glass laminate 10 is peeled at the interface of the adhesive layer 14 and the glass substrate 16, and separates into the glass substrate 16 and the support substrate 18 with an attached adhesive layer.

The peel strength (x) is preferably sufficiently higher than the peel strength (y). Increasing the peel strength (x) means that the attachment force of the adhesive layer 14 to the support substrate 12 is increased and that it is possible to maintain a relatively high attachment force than that to the glass substrate 16 after a heat treatment.

Increasing the attachment force of the adhesive layer 14 with respect to the support substrate 12 may be achieved by, for example, as described below, a method for forming the adhesive layer 14 on the support substrate 12 (preferably, curing a curable resin on the support substrate 12 to form a predetermined adhesive layer 14). It is possible to form the adhesive layer 14 bonded to the support substrate 12 with a high bonding force by the adhesion force at the time of formation.

Meanwhile, the bonding force of the adhesive layer 14 after curing with respect to the glass substrate 16 is usually lower than the bonding force generated at the formation described above. Accordingly, forming the adhesive layer 14 on the support substrate 12 and then laminating the glass substrate 16 on the surface of the adhesive layer 14 makes it possible to manufacture the glass laminate 10 satisfying the desired peeling relationship.

In the above description, increasing the peel strength (x) has been described; however, for example, the difference between the peel strength (x) and the peel strength (y) may be increased by decreasing the peel strength (y). Methods for decreasing the peel strength (y) include a method for decreasing the surface energy of the surface of the glass substrate 16.

Examples of methods of decreasing the surface energy of the surface of the glass substrate 16 include treatment of the first main surface of the glass substrate with a peeling agent.

As the peeling agent, it is possible to use a known peeling agent and examples thereof include a silicone-based compound (for example, silicone oil or the like), a silylation agent (for example, hexamethyldisilazane or the like), a fluorine-based compound (for example, a fluorine resin or the like), and the like. The peeling agent can be used as an emulsion-type, a solvent-type or a solventless-type agent. From the viewpoint of peeling force, safety, cost, and the like, one preferable example is a compound including a methylsilyl group (any one of ≡SiCH₃, ═Si(CH₃)₂, —Si(CH₃)₃) or a fluoroalkyl group (—CmF₂ₘ₊₁) (m is preferably an integer of 1 to 6), and another preferable example is a silicone-based compound or a fluorine-based compound, and a silicone oil is particularly preferable.

In the glass laminate 10, there are no bubbles or, when there are bubbles, the diameter of the bubbles is 10 mm or less, in a boundary between the adhesive layer 14 and the glass substrate 16. That is, one of the following two conditions is satisfied.
Condition A: There are no bubbles between the adhesive layer 14 and the glass substrate 16.
Condition B: There are bubbles between the adhesive layer 14 and the glass substrate 16, and the diameter of the bubbles is 10 mm or less.

As a method for confirming the presence or absence of bubbles, the glass laminate 10 is visually observed from the normal direction of the surface of the glass substrate 16, and the presence or absence of bubbles in the observation region between the adhesive layer 14 and the glass substrate 16 (the observation region is the whole region between the adhesive layer 14 and the glass substrate 16, in other words, the entire surface region of the glass substrate 16 in contact with the adhesive layer 14, which corresponds to so-called full-surface observation (observation of the entire surface of the glass substrate 16)) is confirmed.

A case where there are no bubbles in the observation region is referred to as “there are no bubbles” in the condition A. The visual observation limit is approximately 0.1 mm in diameter. In a case where there are bubbles, the diameter of the bubbles is measured. Here, in a case where the bubbles are not perfectly circular, the circle equivalent diameter is set as the above diameter. The circle equivalent diameter is the diameter of a circle having an area equal to the area of observed bubble.

In the case of the condition B, the diameter of the bubbles is 10 mm or less. In this case, it is intended that all bubbles present between the adhesive layer 14 and the glass substrate 16 have a diameter of 10 mm or less. From the viewpoint that cracking is suppressed to a greater extent when peeling off the glass substrate (also simply referred to below as a “more excellent effect of the present invention”), the diameter of the bubbles is preferably 7 mm or less, and more preferably 5 mm or less. The lower limit of the diameter of the bubbles is not particularly limited and an example thereof includes approximately 0.1 mm which is the visual observation limit described above.

In the case of the condition B, the number of bubbles is not particularly limited, but is preferably 7/1200 cm² or less, and more preferably 3/1200 cm² or less, from the viewpoint of a more excellent effect of the present invention. The lower limit is not particularly limited, but 0 (condition A) is preferable. The “number/1200 cm²” is intended to be the number of bubbles in the observation region (1200 cm²).

It is possible to manufacture a glass laminate satisfying the condition A and condition B described above through a manufacturing method described below.

A detailed description will be given below of each layer (the support substrate 12, the glass substrate 16 and the adhesive layer 14) constituting the glass laminate 10, and then a detailed description will be given of the method for manufacturing the glass laminate 10.

### <Support Substrate>

The support substrate 12 supports and reinforces the glass substrate 16, and prevents deformation, damage, breakage, or the like of the glass substrate 16 when manufacturing a member for an electronic device in a member forming step (a step of manufacturing a member for an electronic device) described below.

As the support substrate 12, for example, a glass sheet, a plastic sheet, a metal sheet such as a SUS sheet, or the like is used. Generally, since the member forming step involves a heat treatment, the support substrate 12 is preferably formed of a material having a small difference in linear expansion coefficient with respect to the glass substrate 16. More preferably, the support substrate 12 is formed of the same material as the glass substrate 16, that is, the support substrate 12 is preferably a glass sheet. In particular, the support substrate 12 is preferably a glass sheet formed of a glass material having the same composition as the glass substrate 16.

The support substrate 12 has, for example, a rectangular shape, and the length of the long side of the support substrate 12 is preferably 400 mm or more and the length of the short side of the support substrate 12 is preferably 300 mm or more. The upper limit of the length of the long side is not particularly limited; however, from the viewpoint of handling, it is often 3200 mm or less. In addition, the upper limit of the length of the short side is not particularly limited; however, from the viewpoint of handling, it is often 3000 mm or less.

The size of the support substrate 12 is preferably equivalent to or greater than that of the glass substrate 16 described below.

The contact area between the support substrate 12 and the adhesive layer 14 described below is 1200 cm² or more. The upper limit of the contact area is not particularly limited; however, it may be 96000 cm² or less.

The entire surface of the support substrate 12 is preferably in contact with the adhesive layer 14. If a part is in a state of being peeled off, there is a possibility that the entire glass substrate 16 may be peeled off starting from that part and, as a result, there is a concern of contamination in the steps or device breakage.

The thickness of the support substrate 12 may be thicker than, may be thinner than or may be the same with that of the glass substrate 16. The thickness of the support substrate 12 is preferably selected based on the thickness of the glass substrate 16, the thickness of the adhesive layer 14, and the thickness of the glass laminate 10. For example, in a case where the current member forming step is designed to process a substrate having a thickness of 0.5 mm and the sum of the thickness of the glass substrate 16 and the thickness of the adhesive layer 14 is 0.1 mm, the thickness of the support substrate 12 is set to 0.4 mm. In a usual case, the thickness of the support substrate 12 is preferably 0.2 to 5.0 mm.

In a case where the support substrate 12 is a glass sheet, the thickness of the glass sheet is preferably 0.08 mm or more for reasons such as ease of handling and resistance to cracking. In addition, the thickness of the glass sheet is preferably 1.0 mm or less for the reason that rigidity is desired such that the sheet bends appropriately without breaking when carrying out the peeling after forming the member for an electronic device.

The difference in the average linear expansion coefficient between the support substrate 12 and the glass substrate 16 at 25 to 300° C. is preferably 500×10⁻⁷/° C. or less, more preferably 300×10⁻⁷/° C. or less, and even more preferably 200×10⁻⁷/° C. or less. If the difference is excessively large, there is a possibility that the glass laminate 10 will warp violently or the support substrate 12 and the glass substrate 16 will peel apart in heating and cooling in the member forming step. In a case where the material of the support substrate 12 is the same as the material of the glass substrate 16, it is possible to suppress the occurrence of such problems.

In the support substrate 12 (preferably, a glass sheet), it is preferred that at least one corner thereof is chamfered (or ground and chamfered), and it is more preferred that the end surfaces thereof are chamfered (or ground and chamfered). When chamfering is performed as described above, chipping from the corners (or end surfaces) of the support substrate 12 does not easily occur, and foreign matter (glass powder in a case where the support substrate is a glass sheet) is less easily generated.

When manufacturing the glass laminate 10, there are many cases where the support substrate 12 is transported, or the work is performed while holding the end surfaces of the support substrate 12. At that time, when the corner (or the end surface) of the support substrate 12 is chamfered, chipping from the corner (or the end surface) does not easily occur, and foreign matter such as glass powder is less easily generated. Therefore, when the adhesive layer 14 and the glass substrate 16 are laminated, it is possible to further prevent foreign matter (for example, glass powder) from being interposed therebetween. As a result, it is possible to suppress the generation of bubbles caused by glass powder between the adhesive layer 14 and the glass substrate 16.

### <Glass Substrate>

In the glass substrate 16, the first main surface 16a thereof is in contact with the adhesive layer 14, and the member for an electronic device is provided on the second main surface 16b on the opposite side to the adhesive layer 14 side.

The type of the glass substrate 16 may be a general one and examples thereof include a glass substrate for a display device such as an LCD or an OLED. The glass substrate 16 is excellent in chemical resistance and moisture resistance, and has a low thermal shrinkage rate. As the index of the thermal shrinkage rate, the linear expansion coefficient specified in JIS R 3102 (revised in 1995) is used.

When the linear expansion coefficient of the glass substrate 16 is large, since the member forming step is often accompanied by a heat treatment, various inconveniences easily occur. For example, in a case of forming a TFT on the glass substrate 16, when the glass substrate 16 on which the TFT has been formed under heating is cooled, there is a concern that the positional shift of the TFT may be excessively large due to thermal shrinkage of the glass substrate 16.

The glass substrate 16 is obtained by melting a glass raw material and forming the molten glass into a sheet shape. Such a forming method may be a general one and, for example, a float process, a fusion process, a slot down draw process, a Fourcault process, a Lubbers process, or the like may be used. In addition, the glass substrate 16 having a particularly small thickness is formed and obtained by a method (a redraw method) of heating the glass formed into a plate shape to a formable temperature and extending and thinning it with a drawing means or the like.

The type of the glass of the glass substrate 16 is not particularly limited, but an oxide-based glass containing silicon oxide as the main component, such as alkali-free borosilicate glass, borosilicate glass, soda-lime glass, high silica glass, or the like is preferable. As the oxide-based glass, a glass having a silicon oxide content of 40 to 90 mass % in terms of oxide is preferable.

As the glass of the glass substrate 16, glass suitable for the type of the member for an electronic device and manufacturing steps thereof is adopted. For example, a glass substrate for a liquid crystal panel is formed of a glass (alkali-free glass) substantially not containing alkali metal components since dissolution of an alkali metal component easily affects the liquid crystal (provided that alkaline earth metal components are included normally). As described above, the glass of the glass substrate 16 is appropriately selected based on the type of the device to which the glass is applied and the manufacturing steps thereof.

The glass substrate 16 is, for example, rectangular in shape, and the length of the long side of the glass substrate 16 is preferably 400 mm or more. The upper limit is not particularly limited; however, from the viewpoint of handling, it is often 3200 mm or less.

The length of the short side of the glass substrate 16 is preferably 300 mm or more. The upper limit is not particularly limited; however, from the viewpoint of handling, it is often 3000 mm or less.

The contact area between the glass substrate 16 and the adhesive layer 14 described below is 1200 cm² or more. The upper limit of the contact area is not particularly limited and may be 96000 cm² or less.

The entire surface of the glass substrate 16 is preferably in contact with the adhesive layer 14.

From the viewpoint of thinning and/or weight reduction of the glass substrate 16, the thickness of the glass substrate 16 is 0.3 mm or less, preferably 0.2 mm or less, more preferably 0.15 mm or less, and particularly preferably 0.10 mm or less. In a case where the thickness is 0.3 mm or less, it is possible to impart favorable flexibility to the glass substrate 16. In a case of 0.15 mm or less, it is possible to wind the glass substrate 16 into a roll state.

In addition, the thickness of the glass substrate 16 is preferably 0.03 mm or more for reasons such as ease of manufacturing of the glass substrate 16 and ease of handling of the glass substrate 16.

In the glass substrate 16, it is preferred that at least one corner is chamfered (or ground and chamfered) and it is more preferred that the end surfaces are chamfered (or ground and chamfered). When chamfering is performed as described above, chipping from the corners (or end surfaces) of the glass substrate 16 does not easily occur, and glass powder is not easily generated.

When manufacturing the glass laminate 10, there are many cases where the glass substrate 16 is transported, or the work is performed while holding the end surfaces of the glass substrate 16. At that time, when the corner (or the end surface) of the glass substrate 16 is chamfered, glass powder from the corner (or the end surface) is not easily generated and when the adhesive layer 14 and the glass substrate 16 are laminated, it is possible to further prevent glass powder from being interposed therebetween. As a result, it is possible to suppress the generation of bubbles caused by glass powder between the adhesive layer 14 and the glass substrate 16.

### <Adhesive Layer>

The adhesive layer 14 prevents a positional shift of the glass substrate 16 until the operation of separating the glass substrate 16 and the support substrate 12 is performed and prevents the glass substrate 16 from being damaged by the separation operation. The surface 14a of the adhesive layer 14 in contact with the glass substrate 16 is peelably adhered to the first main surface 16a of the glass substrate 16. The adhesive layer 14 is bonded to the first main surface 16a of the glass substrate 16 with a weak bonding force, and the peel strength (y) at this interface is smaller than the peel strength (x) at the interface between the adhesive layer 14 and the support substrate 12.

That is, at the time of separating the glass substrate 16 and the support substrate 12, peeling occurs at the interface between the first main surface 16a of the glass substrate 16 and the adhesive layer 14 and peeling does not easily occur at the interface between the support substrate 12 and the adhesive layer 14. Therefore, although the adhesive layer 14 is adhered to the first main surface 16a of the glass substrate 16, it has surface characteristics allowing easy peeling of the glass substrate 16.

That is, the adhesive layer 14 is bonded to the first main surface 16a of the glass substrate 16 with a some extent of bonding force so as to prevent positional shift of the glass substrate 16 and, at the same time, is bonded with a bonding force such that it is possible to easily carry out the peeling without breaking the glass substrate 16 when peeling off the glass substrate 16. In the present invention, the property of allowing easy peeling of the surface of the adhesive layer 14 is referred to as peelability. Meanwhile, the first main surface of the support substrate 12 and the adhesive layer 14 are bonded with a bonding force such that peeling is relatively difficult.

The bonding force at the interface between the adhesive layer 14 and the glass substrate 16 may be changed before and after forming a member for an electronic device on the surface (the second main surface 16b) of the glass substrate 16 of the glass laminate 10 (that is, the peel strength (x) and the peel strength (y) may be changed). However, even after the member for an electronic device is formed, the peel strength (y) is smaller than the peel strength (x). It is considered that the adhesive layer 14 and the layer of the glass substrate 16 are bonded to each other with weak adhesion force or a bonding force due to van der Waals force. In the case of forming the adhesive layer 14 and then laminating, on the surface thereof, the glass substrate 16, for example, when the adhesive layer 14 is the resin layer described below, in a case where the resin of the adhesive layer 14 is sufficiently cross- linked so as not to exhibit adhesion force, it is considered that the bonding is carried out with a bonding force due to van der Waals force.

However, the resin of the adhesive layer 14 often has a weak adhesion force to some extent. Even in a case where adhesion is extremely low, it is considered that, when arranging the member for an electronic device on the glass laminate 10 after manufacturing the glass laminate 10, the resin of the adhesive layer 14 is adhered to the glass substrate 16 surface by a heating operation or the like and the bonding force between the adhesive layer 14 and the layer of the glass substrate 16 increases.

Therefore, in some cases, it is also possible to subject the surface of the adhesive layer 14 before lamination and the first main surface 16a of the glass substrate 16 before lamination to a process of weakening the bonding force therebetween, followed by lamination. Performing a non-adhesion treatment or the like on the surface to be laminated and then carrying out laminating weakens the bonding force at the interface between the adhesive layer 14 and the layer of the glass substrate 16 and makes it possible to reduce the peel strength (y).

In addition, the adhesive layer 14 is bonded to the surface of the support substrate 12 with a strong bonding force such as adhesion force or a pressure-sensitive adhesive force. For example, as described below, curing a layer including a curable resin on the surface of the support substrate 12 makes it possible to obtain a high bonding force by attaching a resin as a cured product to the surface of the support substrate 12. In addition, it is also possible to carry out a treatment (for example, a treatment using a coupling agent) for generating a strong bonding force between the surface of the support substrate 12 and the adhesive layer 14 to increase the bonding force between the surface of the support substrate 12 and the adhesive layer 14.

Bonding the adhesive layer 14 and the layer of the support substrate 12 with a high bonding force means that the peel strength (x) at the interface between the two is large.

The size of the adhesive layer 14 is not particularly limited, but is usually preferably equal to or greater than that of the glass substrate 16. More specifically, the adhesive layer 14 is usually preferably in contact with the entire surface of the glass substrate 16. Specifically, the adhesive layer 14 preferably has a rectangular shape. In the case of a rectangular shape, the length of the long side of the adhesive layer 14 is preferably 400 mm or more, and the upper limit thereof is not particularly limited, but from the viewpoint of handling, it is often 3200 mm or less. In addition, the length of the short side of the adhesive layer 14 is preferably 300 mm or more, and the upper limit is not particularly limited, but, from the viewpoint of handling, it is often 3000 mm or less. The adhesive layer 14 is preferably arranged on the entire surface of the support substrate 12.

Although the thickness of the adhesive layer 14 is not particularly limited, it is preferably 2 to 100 μm, more preferably 3 to 50 μm, and even more preferably 7 to 20 μm. When the thickness of the adhesive layer 14 is in such a range, even if bubbles or a foreign substance are interposed between the adhesive layer 14 and the glass substrate 16, it is possible to suppress the occurrence of distortion defects in the glass substrate 16.

Although the type of the adhesive layer 14 is not particularly limited, it may be an organic layer formed of a resin or the like, or an inorganic layer.

The organic layer is preferably a resin layer including a predetermined resin. The type of the resin forming the resin layer is not particularly limited, and examples thereof include fluororesins, acrylic resins, polyolefin resins, polyurethane resins, polyimide resins, silicone resins, and the like. It is also possible to mix and use several types of resins. Among these, a silicone resin is preferable. That is, the adhesive layer 14 is preferably a silicone resin layer. This is because silicone resin is excellent in heat resistance and peelability. In addition, this is because fixing to a glass sheet is easy through a condensation reaction with a silanol group on the glass sheet surface. A silicone resin is also preferable in that the peelability does not substantially degrade even when treated in air at approximately 200° C. for about 1 hour.

The silicone resin included in the silicone resin layer is preferably a cross-linked product of a cross-linkable organopolysiloxane, and the silicone resin preferably forms a three-dimensional network structure.

The type of the cross-linkable organopolysiloxane is not particularly limited. As long as it is cross-linked and cured through a predetermined cross-linking reaction to become a cross-linked product (cured product) constituting the silicone resin, the structure thereof is not particularly limited and it may have a predetermined cross-linking property. The form of the cross-linking is not particularly limited, and it is possible to appropriately adopt a known form according to the type of cross-linkable group included in the cross-linkable organopolysiloxane. Examples thereof include a hydrosilylation reaction, a condensation reaction, and a radical reaction with a heat treatment, a high-energy ray treatment or a radical polymerization initiator.

More specifically, in a case where the cross-linkable organopolysiloxane has a radical reactive group such as an alkenyl group or an alkynyl group, it is cross-linked by reaction between the radical reactive groups via the above radical reaction to form a cured product (cross-linked silicone resin).

In addition, in a case where the cross-linkable organopolysiloxane has a silanol group, it is cross-linked by a condensation reaction between the silanol groups to form a cured product.

Furthermore, in a case where the cross-linkable organopolysiloxane includes an organopolysiloxane having an alkenyl group (such as a vinyl group) bonded to a silicon atom (that is, an organoalkenylpolysiloxane) and an organopolysiloxane having a hydrogen atom (a hydrosilyl group) bonded to a silicon atom (that is, organohydrogenpolysiloxane), the cross-linking is carried out by a hydrosilylation reaction in the presence of a hydrosilylation catalyst (for example, a platinum-based catalyst) to form a cured product.

Among these, from the viewpoint of easily forming the adhesive layer 14 and more excellent peelability of the glass substrate, preferred form is that the cross-linkable organopolysiloxane includes an organopolysiloxane having an alkenyl group at both terminals and/or a side chain (also referred to below as organopolysiloxane A as appropriate) and an organopolysiloxane having a hydrosilyl group at both terminals and/or a side chain (also referred to below as organopolysiloxane B as appropriate).

Here, the alkenyl group is not particularly limited and examples thereof include a vinyl group (ethenyl group), an allyl group (2-propenyl group), a butenyl group, a pentenyl group, a hexynyl group, and the like. Above all, a vinyl group is preferable from the viewpoint of excellent heat resistance.

Examples of groups other than the alkenyl group included in the organopolysiloxane A and groups other than the hydrosilyl group included in the organopolysiloxane B include alkyl groups (particularly, alkyl groups having 4 or less carbon atoms).

The position of the alkenyl group in the organopolysiloxane A is not particularly limited, but in a case where the organopolysiloxane A is linear, the alkenyl group may be present in any of the M unit and the D unit shown below, or may be present in both the M unit and the D unit. From the viewpoint of the curing rate, it is preferably present in at least the M unit, and preferably present in both of two M units.

The M unit and the D unit are examples of basic constituent units of the organopolysiloxane. The M unit is a monofunctional siloxane unit in which three organic groups are bonded, and the D unit is a difunctional siloxane unit in which two organic groups are bonded. In a siloxane unit, since the siloxane bond is a bond in which two silicon atoms are bonded via one oxygen atom, the number of oxygen atoms per one silicon atom in the siloxane bond is regarded as 1/2, and is expressed in the formula as O_{1/2}.

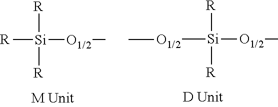

The number of alkenyl groups in the organopolysiloxane A is not particularly limited, but is preferably 1 to 3, and more preferably 2 in each molecule.

The position of the hydrosilyl group in the organopolysiloxane B is not particularly limited, but in a case where the organopolysiloxane A is linear, the hydrosilyl group may be present in either the M unit or D unit, or may be present in both the M unit and D unit. From the viewpoint of the curing rate, it is preferably present in at least the D unit.

The number of hydrosilyl groups in the organopolysiloxane B is not particularly limited, but it is preferable that at least 3 groups are contained per one molecule, and 3 groups are more preferred.

The mixing ratio of the organopolysiloxane A and the organopolysiloxane B is not particularly limited, but the molar ratio of the hydrogen atom bonded to the silicon atom in the organopolysiloxane B to the total alkenyl groups in the organopolysiloxane A (hydrogen atom/alkenyl group) is preferably adjusted to 0.15 to 1.3. The mixing ratio is adjusted to more preferably 0.7 to 1.05, and even more preferably 0.8 to 1.0.

As the hydrosilylation catalyst, it is preferable to use a platinum group metal-based catalyst. Examples of the platinum group metal-based catalyst include platinum group-based, palladium group-based, and rhodium group-based catalysts. In particular, it is preferable to use a platinum-based catalyst from the viewpoint of economy and reactivity. As the platinum group metal-based catalyst, known ones can be used. Specific examples thereof include platinum fine powder, platinum black, chloroplatinic acids such as primary chloroplatinic acid and secondary chloroplatinic acid, platinum tetrachloride, alcohol compounds and aldehyde compounds of chloroplatinic acid, olefin complexes, alkenylsiloxane complexes and carbonyl complexes of platinum, and the like.

The use amount of the hydrosilylation catalyst is preferably 1 to 10,000 mass ppm and more preferably 10 to 1,000 mass ppm, with respect to the total mass of the organopolysiloxane A and the organopolysiloxane B.

The number average molecular weight of the cross-linkable organopolysiloxane is not particularly limited, but in view of excellent handling properties, excellent film formability, and greater suppression of decomposition of the silicone resin under high temperature treatment conditions, the weight average molecular weight in terms of polystyrene as measured by GPC (gel permeation chromatography) is preferably 1,000 to 5,000,000, and more preferably 2,000 to 3,000,000.

The viscosity of the cross-linkable organopolysiloxane is preferably 10 to 5,000 mPa·s, and more preferably 15 to 3,000 mPa·s.

The materials constituting the inorganic layer are not particularly limited, but it is preferable to include at least one selected from the group consisting of, for example, oxides, nitrides, oxynitrides, carbides (which may be so-called carbon materials and for example, carbides obtained by sintering a resin component such as a phenol resin), carbonitrides, silicides, and fluorides.

### <Method for Manufacturing Glass Laminate>

The method for manufacturing the glass laminate 10 of the present invention is not particularly limited as long as it is possible to manufacture a glass laminate satisfying the condition A or condition B described above.

In particular, in a case where the adhesive layer 14 is a resin layer, from the viewpoint of being able to easily manufacture the glass laminate 10, preferable examples include a method for manufacturing the glass laminate 10 including an adhesive layer forming step of forming a layer including a curable resin on the support substrate 12, followed by curing on the support substrate 12 to form an adhesive layer 14 (resin layer), and a lamination step of laminating the glass substrate 16 on the adhesive layer 14, in which Requirement 1 and Requirement 2 below are satisfied.

(Requirement 1): At least one of corners (preferably end surfaces) of at least one of the support substrate 12 and the glass substrate 16 is chamfered and/or at least one of the support substrate 12 and the glass substrate 16 is subjected to an ultrasonic cleaning treatment.

(Requirement 2): The adhesive layer forming step is carried out in an environment with a cleanliness of class 1000 or less and/or a peelable protective film is arranged on at least one surface of the adhesive layer 14 and the glass substrate 16 until before the adhesive layer 14 and the glass substrate 16 are laminated.

Below, first, a description will be given of the procedures of the adhesive layer forming step and the lamination step, then the description will be given of (Requirement 1) and (Requirement 2) above.

### (Adhesive Layer Forming Step)

This step is a step of forming a layer including a curable resin on the surface of the support substrate 12 and curing the curable resin on the surface of the support substrate 12 to form the adhesive layer 14 (resin layer). When the curable resin is cured on the surface of the support substrate 12, it is adhered by interaction with the surface of the support substrate 12 during the curing reaction, and the peel strength between the resin and the surface of the support substrate 12 increases. Accordingly, even if the glass substrate 16 and the support substrate 12 are formed of the same material, it is possible to provide a difference in peel strength between the glass substrate 16 and the support substrate 12 with respect to the adhesive layer 14.

In order to form a layer including a curable resin on the support substrate 12, it is preferable to use a curable resin composition including a curable resin and coat the composition onto the support substrate 12 to form a layer including a curable resin.

The curable resin to be used may be any resin as long as the adhesive layer described above can be formed, and examples thereof include a curable silicone resin (cross-linkable organopolysiloxane), a curable acrylic resin, a polyimide resin precursor, and the like.

Here, from the viewpoint that the coating property of the composition is favorable and it is possible to perform the coating at a higher speed and from the viewpoint that the flatness of the coating film is improved, a solvent is preferably included in the curable resin composition. The type of the solvent is not particularly limited, and examples thereof include butyl acetate, heptane, 2-heptanone, 1-methoxy-2-propanol acetate, toluene, xylene, THF, chloroform, dialkyl polysiloxane, saturated hydrocarbon, and the like.

A method for coating the curable resin composition on the surface of the support substrate 12 is not particularly limited, and it is possible to use a known method. Examples thereof include a spray coating method, a die coating method, a spin coating method, a dip coating method, a roll coating method, a bar coating method, a screen printing method, a gravure coating method, and the like.

Thereafter, as necessary, drying treatment for removing the solvent may be carried out. The method of the drying treatment is not particularly limited, but examples thereof include a method for removing the solvent under reduced pressure conditions, a method for heating at a temperature at which curing of the curable resin does not proceed, and the like.

Subsequently, the layer including the curable resin on the support substrate 12 is subjected to a curing treatment to cure the curable resin in the layer and to form the adhesive layer 14. More specifically, as illustrated in (A) of FIG. 2, the adhesive layer 14 is formed on the surface of at least one side of the support substrate 12 in this step.

As a method for curing (cross-linking), thermal curing is usually adopted.

For the temperature conditions when the curable resin is subjected to reaction, the optimum conditions are selected as appropriate according to the type of the curable resin to be used; however, for example, in a case of using a curable silicone resin, the heating temperature is preferably 80 to 250° C., and the heating time is preferably 10 to 120 minutes.

### (Lamination Step)

The lamination step is a step of laminating the glass substrate 16 on the resin surface of the adhesive layer 14 obtained in the adhesive layer forming step described above to obtain the glass laminate 10 provided with the support substrate 12, the adhesive layer 14 and the glass substrate 16 in this order. More specifically, as illustrated in (B) of FIG. 2, the adhesive layer 14 and the glass substrate 16 are laminated with the surface 14a of the adhesive layer 14 on the opposite side to the support substrate 12 side and the first main surface 16a of the glass substrate 16, which has the first main surface 16a and the second main surface 16b, as the lamination surfaces to obtain the glass laminate 10.

The method for laminating the glass substrate 16 on the adhesive layer 14 is not particularly limited, and it is possible to adopt a known method.

Examples thereof include a method of overlapping the glass substrate 16 on the surface of the adhesive layer 14 under a normal pressure environment. As necessary, after overlapping the glass substrate 16 on the surface of the adhesive layer 14, the glass substrate 16 may be pressure bonded to the adhesive layer 14 by using a roll or a press. Bubbles interposed between the adhesive layer 14 and the layer of the glass substrate 16 are relatively easily removed by pressure bonding by a roll or a press, which is preferable.

Pressure bonding by a vacuum lamination method or a vacuum press method is more preferable because the interposition of bubbles is suppressed and favorable adhesion is secured. Pressure bonding under a vacuum also has the advantage that, even in a case where minute bubbles remain, heating does not cause the bubbles to grow and distortion defects of the glass substrate 16 are not easily caused.

One preferable aspect of the lamination step is to laminate the glass substrate 16 on the adhesive layer 14 while heating the adhesive layer 14. In other words, it is preferable to heat and laminate the adhesive layer 14 and the glass substrate 16. Carrying out the lamination step according to the above procedure decreases the moisture content of the adhesive layer 14 and makes it difficult for bubbles to be generated between the adhesive layer 14 and the glass substrate 16 when the glass laminate 10 is heated.

The method for heating the adhesive layer 14 is not particularly limited and, for example, a known heater or the like may be used.

The heating temperature of the adhesive layer 14 is different according to the type of the resin to be used, but it is preferably 100° C. or more, and more preferably 120° C. or more. Although the upper limit is not particularly limited, it is preferably 200° C. or less from the viewpoint of being able to further suppress decomposition of the resin.

### (Requirement 1)

As the Requirement 1, at least one of the corners (preferably end surfaces) of at least one of the support substrate 12 and the glass substrate 16 is chamfered and/or at least one of the support substrate 12 and the glass substrate 16 is subjected to an ultrasonic cleaning treatment. That is, it is sufficient if at least one of the following applies: the chamfering process is performed on at least one of the support substrate 12 and the glass substrate 16, or at least one of the support substrate 12 and the glass substrate 16 is subjected to ultrasonic cleaning treatment. Here, the treatment with respect to the support substrate 12 is usually carried out before the adhesive layer forming step, and the treatment with respect to the glass substrate 16 is usually carried out before the lamination step.

The treatment carried out in the Requirement 1 mainly plays a role of removing foreign matter generated by chipping of the support substrate 12 and the glass substrate 16. For example, as described above, glass powder tends to be generated from the end surface portions of the glass substrate 16. Therefore, carrying out the chamfering treatment makes it possible to suppress the occurrence of glass powder in the first place. In addition, carrying out the ultrasonic cleaning treatment makes possible to remove foreign matter (for example, glass powder) attached to the support substrate 12 and the glass substrate 16.

The method for chamfering performed in the Requirement 1 is not particularly limited and a known method may be carried out.

The positions at which the chamfering treatment is performed on the support substrate 12 and the glass substrate 16 is not particularly limited, but at least one of the corners is preferable, at least one of the end surfaces is more preferable, and all of the end surfaces is even more preferable.

The method for ultrasonic cleaning treatment carried out in the Requirement 1 is not particularly limited and a known method may be carried out, but the ultrasonic cleaning treatment is preferably performed while immersing the support substrate 12 (or the glass substrate 16) in various solvents.

The number of times of the ultrasonic cleaning treatment is not particularly limited, and the treatment is preferably carried out at least once and is preferably carried out a plurality of times.

In addition, the type of the solvent used in the ultrasonic cleaning treatment is not particularly limited, but examples thereof include water and an organic solvent.

Furthermore, the time for carrying out the ultrasonic cleaning treatment is not particularly limited, but is preferably 30 seconds or more, more preferably 1 minute or more, from the viewpoint of a more excellent effect of the present invention. Although the upper limit is not particularly limited, it is preferably 10 minutes or less from the viewpoint of productivity.

After the ultrasonic cleaning treatment, as necessary, a drying treatment may be carried out in order to remove various solvents.

### (Requirement 2)

As the Requirement 2, the adhesive layer forming step is carried out in an environment with a cleanliness of class 1000 or less and/or a peelable protective film is arranged on a surface of at least one of the adhesive layer 14 and the glass substrate 16 until before the adhesive layer 14 and the glass substrate 16 are laminated (also simply referred to below as the “protection treatment”). In other words, it is sufficient if at least one of the adhesive layer forming step carried out in an environment with a cleanliness of class 1000 or less, or the protection treatment described above, is carried out.

The treatment performed in the Requirement 2 mainly plays a role of suppressing the adhesion of dust in the air to the surfaces of the adhesive layer 14 and the glass substrate 16. When a large amount of dust is positioned on the lamination surface of the adhesive layer 14 and the glass substrate 16, this may cause bubbles to be interposed therein. Therefore, by performing at least either one of the above processes, it is possible to suppress the adhesion of dust.

The adhesive layer forming step carried out in the Requirement 2 is performed in an environment having a cleanliness of class 1000 or less.

In the present specification, “class (cleanliness class)” means a cleanliness class prescribed by the United States Federal Standard (USA FED. STD) 209 D, and “class 1000” means an atmosphere in which the number of fine particles having a particle size of 0.5 μm or less included in the air does not exceed 1000 per one cubic foot (1 ft³). The cleanliness class 1000 prescribed by the United States Federal Standard 209 D corresponds to cleanliness class 6 prescribed in JIS B 9920 “Classification of air cleanliness for cleanrooms”.

The protection treatment carried out in the Requirement 2 is a process of arranging a peelable protective film on a surface of at least one of the adhesive layer 14 and the glass substrate 16 until before laminating the adhesive layer 14 and the glass substrate 16. That is, it is a treatment in which a peelable protective film is arranged on at least one of the lamination surface of the adhesive layer 14 to the glass substrate 16 and the lamination surface of the glass substrate 16 to the adhesive layer 14, thereby preventing dust from attaching thereto. Here, this treatment is usually in place until before the lamination step and, when laminating the adhesive layer 14 and the glass substrate 16, the peelable protective film is peeled off and both are laminated.

The type of the peelable protective film to be used is not particularly limited and may be a film which is able to be attached to and peeled off from the surface of the adhesive layer 14 and the glass substrate 16. Examples thereof include a peelable silicone film and the like.

In addition, in a case where a glass sheet is used as the support substrate and the glass substrate, the glass sheet is normally transported up to a predetermined place after manufacturing and, in this case the transporting is often carried out in the form of a glass sheet packaging that is a laminate of a plurality of glass sheets laminated via composite paper. At that time, using composite paper made of virgin pulp as the composite paper makes the effect of the present invention more excellent. That is, at the time of manufacturing the glass laminate, the glass laminate is preferably manufactured using glass sheets, included in a glass sheet packaging in which a plurality of glass sheets are laminated via composite paper made of virgin pulp, as at least one of the support substrate and the glass substrate of the glass laminate.

Here, the composite paper made of virgin pulp means a composite paper substantially not containing used paper pulp. Substantially not including used paper pulp is intended to mean that the content of used paper pulp is less than 20 mass %. Preferably, the content of the used paper pulp is 5 mass % or less, more preferably 1 mass % or less, and even more preferably 0.1 mass % or less.

For example, in a case where the material pulp of the composite paper substantially includes used paper pulp, foreign particles derived from the used paper pulp are often present in the composite paper. When such foreign matter is present, it is transferred onto a glass sheet, which may result in the generation of bubbles. On the other hand, in a case of composite paper made of virgin pulp, the amount of such foreign matter is small and it is possible to further suppress the generation of bubbles.

Here, “substantially” including used paper pulp means that the content of the used paper pulp with respect to the total mass of the material pulp is 20 mass % or more.

In order to suppress the size of bubbles in the glass laminate, there is preferably no foreign matter attached to the support substrate and the glass substrate to be used. As described above, the attachment of foreign matter from the composite paper (composite paper for packaging) used for packaging may be a problem as a cause of the attachment of foreign matter in some cases. Thus, it is preferable that no foreign matter which may attach to the glass sheet is present on the surface of the composite paper.

At that time, examples of a method for selecting appropriate composite paper include a method of evaluating the composite paper surface as follows.

By using the optical microscope (BX 51 manufactured by Olympus Corp.), the surface of the composite paper to be used for the glass sheet packaging is subjected to a reflected image observation. EOS Kiss X3 manufactured by Canon Inc. is used as a photographing device. Images are acquired with an observation range with a length of 1.24 mm and a width of 0.83 mm, in which an image capture size is 2352×1568 pixels and an image data file format is JPEG.

The optical microscope image obtained above is analyzed by using two-dimensional image analysis software (WinROOF manufactured by Mitani Corp.). A region in which there are no irregularities in the brightness or the like in the image due to the microscope field of view is selected using “rectangular ROI” and then the image is processed with a 3×3 median filter to remove noise. Next, the image is made to be monochrome, and then “binarization with two threshold values” is performed to calculate the area ratio of foreign matter and the other. In the present invention, when setting the two thresholds, 0.000 to 130.000 is adopted in order to select a region in which foreign matter is able to be recognized when the image is visually observed.

As an example of the analysis result, the foreign matter area ratio in each composite paper is 0.0% in virgin pulp composite paper, 9.7% in composite paper A, and 3.7% in composite paper B, confirming that there is less foreign matter in the composite paper made of virgin pulp.

### <Glass Laminate>

It is possible to use the glass laminate 10 of the present invention for various purposes and examples thereof include applications for manufacturing electronic parts such as a display device panel to be described below, a PV, a thin film secondary battery, and a semiconductor wafer having a circuit formed on the surface thereof. In these applications, the glass laminate 10 is often exposed (for example, for one hour or more) to high temperature conditions (for example, 300° C. or higher).

Here, the display device panel includes LCD, OLED, electronic paper, plasma display panel, field emission panel, quantum dot LED panel, MEMS (Micro Electro Mechanical Systems) shutter panel, and the like.

### Second Embodiment

A detailed description will be given below of another embodiment (second embodiment) of the glass laminate according to the present invention.

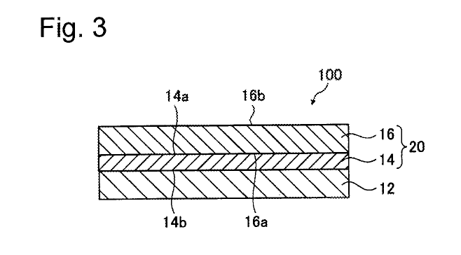

FIG. 3 is a schematic cross-sectional view of an example of a glass laminate according to the present invention.

As illustrated in FIG. 3, a glass laminate 100 is a laminate in which a layer of the support substrate 12, a layer of the glass substrate 16 and the adhesive layer 14 therebetween are present. One surface of the adhesive layer 14 is in contact with the layer of the support substrate 12 and the other surface thereof is in contact with the first main surface 16a of the glass substrate 16.

Each of the layers (the support substrate 12, the glass substrate 16 and the adhesive layer 14) constituting the glass laminate 100 of FIG. 3 are synonymous with each layer constituting the glass laminate 10 described above, and a description thereof is omitted here.

The relationship between the peel strengths of each layer is different between the glass laminate 100 of FIG. 3 and the glass laminate 10 of FIG. 1. More specifically, in the glass laminate 100 of FIG. 3, the adhesive layer 14 is fixed on the glass substrate 16, and a glass substrate 20 with an attached adhesive layer is peelably laminated (adhered) on the support substrate 12 such that the adhesive layer 14 in the glass substrate 20 with an attached adhesive layer is in direct contact with the support substrate 12. As described above, in the present invention, fixing and peelably laminating (adhering) differ in peel strength (that is, the stress required for peeling) and the fixing means that the peel strength is larger than that in the adhering. That is, the peel strength at the interface between the adhesive layer 14 and the glass substrate 16 is larger than the peel strength at the interface between the adhesive layer 14 and the support substrate 12.

More specifically, between (the interface of) the glass substrate 16 and the adhesive layer 14 has a peel strength (z) and when stress is applied in the peeling direction exceeding the peel strength (z) at the interface between the glass substrate 16 and the adhesive layer 14, peeling occurs between the glass substrate 16 and the adhesive layer 14. Between (the interface of) the adhesive layer 14 and the support substrate 12 has a peel strength (w) and when the stress is applied in the peeling direction exceeding the peel strength (w) to the interface between the adhesive layer 14 and the support substrate 12, peeling occurs between the adhesive layer 14 and the support substrate 12.

In the glass laminate 100, the peel strength (z) is larger than the peel strength (w). Accordingly, when a stress is applied to the glass laminate 100 in the direction for peeling the support substrate 12 and the glass substrate 16 apart, the glass laminate 100 of the present invention is peeled at the interface of the adhesive layer 14 and the support substrate 12 and separates into the glass substrate 20 with an attached adhesive layer and the support substrate 12.

Increasing the attachment force of the adhesive layer 14 with respect to the glass substrate 16 may be achieved by, for example, a method for forming the adhesive layer 14 on the glass substrate 16 (preferably, curing a curable resin on the glass substrate 16 to form the predetermined adhesive layer 14). It is possible to form the adhesive layer 14 bonded to the glass substrate 16 with a high bonding force by the adhesion force at the time of curing.

Meanwhile, the bonding force of the adhesive layer 14 after curing with respect to the support substrate 12 is usually smaller than the bonding force generated at the formation described above. Accordingly, forming the adhesive layer 14 on the glass substrate 16 and then laminating the support substrate 12 on the surface of the adhesive layer 14 makes it possible to manufacture the glass laminate 100 satisfying the desired peeling relationship.

In the glass laminate 100, there are no bubbles or, when there are bubbles, the diameter of the bubbles is 10 mm or less, in a boundary between the support substrate 12 and the adhesive layer 14. That is, one of the following two conditions is satisfied.
Condition C: There are no bubbles between the support substrate 12 and the adhesive layer 14.
Condition D: There are bubbles between the support substrate 12 and the adhesive layer 14, and the diameter of the bubbles is 10 mm or less.

The method for confirming the presence/absence of bubbles is the same as the method described in the first embodiment, and the observation region is the entire surface region of the support substrate 12 in contact with the adhesive layer 14.

In the case of the condition D, the preferable ranges and definitions of the diameters and the numbers of bubbles are the same as in the condition B described in the first embodiment.

The method for manufacturing the glass laminate 100 is not particularly limited, but, in the method for manufacturing the glass laminate 10 described above, when the glass substrate 16 is used instead of the support substrate 12 and the support substrate 12 is used instead of the glass substrate 16, it is possible to manufacture the desired glass laminate 100. For example, it is possible to manufacture the glass laminate 100 by forming the adhesive layer 14 on the glass substrate 16 and then laminating the support substrate 12 on the adhesive layer 14.

Here, it is also preferable to satisfy the Requirements 1 and 2 described above in this case.

<Electronic Device (Glass Substrate with Attached Member) and Manufacturing Method thereof>

In the present invention, it is possible to manufacture an electronic device by using the glass laminate described above (the glass laminate 10 or the glass laminate 100).

A detailed description will be given below of an aspect using the glass laminate 10 described above.

By using the glass laminate 10, an electronic device (a glass substrate with an attached member) including a glass substrate and a member for an electronic device can be manufactured.

The method for manufacturing the electronic device is not particularly limited, but from the viewpoint of excellent productivity of the electronic device, preferred is a method for forming a member for an electronic device on a glass substrate in the glass laminate to manufacture a laminate with an attached member for an electronic device and separating the obtained laminate with an attached member for an electronic device into the glass substrate with an attached member and the support substrate with an attached adhesive layer with the glass substrate side interface of the adhesive layer as a peeling surface.

Below, the step of forming a member for an electronic device on the glass substrate in the glass laminate to manufacture a laminate with an attached member for an electronic device is termed a member forming step and a step of separating the laminate with an attached member for an electronic device into the glass substrate with an attached member and a support substrate with an attached adhesive layer with the glass substrate side interface of the adhesive layer as the peeling surface is termed a separation step.

A detailed description will be given below of the materials and procedures used in each step.

### (Member Forming Step)

The member forming step is a step of forming a member for an electronic device on the glass substrate 16 in the glass laminate 10 obtained in the lamination step described above. More specifically, as illustrated in (C) of FIG. 2, a member for an electronic device 22 is formed on the second main surface 16b (exposed surface) of the glass substrate 16 to obtain a laminate 24 with an attached member for an electronic device.

First, a detailed description will be given of the member for an electronic device 22 used in this step, and then a detailed description will be given of the procedures of the steps.

### (Member for an Electronic Device (Functional Element))

The member for an electronic device 22 is a member formed on the glass substrate 16 in the glass laminate 10 and constituting at least a part of the electronic device. More specifically, examples of the member for an electronic device 22 include members used for an electronic component such as a display device panel, a photovoltaic cell, a thin film secondary battery, or a semiconductor wafer having a circuit formed on the surface thereof (for example, a member for a display device, a member for a photovoltaic cell, a member for a thin film secondary battery, or a circuit for an electronic component).

Examples of members for a photovoltaic cell include, as a silicon-type one, a transparent electrode such as a tin oxide of a positive electrode, a silicon layer represented by a p layer/i layer/n layer, a metal of a negative electrode, and the like, as well as various members corresponding to a compound-type, a dye sensitization-type, a quantum dot-type, and the like.

In addition, examples of members for a thin film secondary battery include, as a lithium ion-type one, a transparent electrode such as a metal or a metal oxide of a positive electrode or a negative electrode, a lithium compound of an electrolyte layer, a metal of a current collecting layer, a resin as a sealing layer, and the like, as well as various members corresponding to a nickel hydrogen-type, a polymer-type, a ceramic electrolyte-type, and the like.

In addition, examples of circuits for electronic components include, as CCDs or CMOSs, metals for a conductive portion, silicon oxide or silicon nitride for an insulating portion, and the like, as well as various sensors such as a pressure sensor and an acceleration sensor or various members corresponding to a rigid printed circuit board, a flexible printed circuit board, a rigid flexible printed circuit board, and the like.

### (Step Procedure)

The method for manufacturing the laminate 24 with an attached member for an electronic device described above is not particularly limited. The member for an electronic device 22 may be formed on the second main surface 16b surface of the glass substrate 16 of the glass laminate 10 by a known method based on the type of the constituent members of the member for an electronic device.

Here, the member for an electronic device 22 may not be all of the members (referred to below as the “all members”) finally formed on the second main surface 16b of the glass substrate 16, but may be a part of all the members (referred to below as “part of the members”). A glass substrate with part of the members attached thereto, which has been peeled from the adhesive layer 14, may be processed to a glass substrate with all members attached thereto (corresponding to an electronic device to be described below) in a subsequent step.

In addition, another member for an electronic device may be formed on the peeling surface (the first main surface 16a) of the glass substrate with all members attached thereto, which has been peeled from the adhesive layer 14. In addition, a laminate with all members attached thereto may be assembled, followed by peeling off the support substrate 12 from the laminate with all members attached thereto, to manufacture an electronic device. Furthermore, two laminates with all members attached thereto may be used and assembled, followed by peeling off the two support substrates 12 from the laminate with all members attached thereto, to manufacture a glass substrate with an attached member having two glass substrates.

For example, taking the case of manufacturing an OLED as an example, in order to form an organic EL structure on the surface (corresponding to the second main surface 16b of the glass substrate 16) of the opposite side to the adhesive layer 14 side of the glass substrate 16 of the glass laminate 10, various layer forming and treatments are performed such as forming a transparent electrode, depositing, on the surface on which the transparent electrode has been formed, a hole injecting layer, a hole transporting layer, a light emitting layer, an electron transporting layer and the like, forming a back electrode, and sealing by using a sealing plate. Specific examples of the layer forming and treatments include film formation treatments, vapor deposition treatments, sealing plate adhesion treatments, and the like.

In addition, for example, in the case of manufacturing a TFT-LCD, there are various types of steps such as a TFT forming step of forming a pattern on a metal film, a metal oxide film or the like formed by a general film forming method such as a CVD method or a sputtering method, by using a resist solution on the second main surface 16b of the glass substrate 16 of the glass laminate 10 to form a thin film transistor (TFT), a CF forming step of forming a color filter (CF) by using a resist solution in the pattern forming on the second main surface 16b of the glass substrate 16 of another glass laminate 10, and a bonding step of laminating the laminate with an attached TFT obtained in the TFT forming step and the laminate with an attached CF obtained in the CF forming step.

In the TFT forming step and the CF forming step, the TFT and CF are formed on the second main surface 16b of the glass substrate 16 by using known photolithography techniques, etching techniques, or the like. At this time, a resist solution is used as a coating solution for pattern formation.

Here, the second main surface 16b of the glass substrate 16 may be cleaned before forming the TFTs or CFs, as necessary. As a cleaning method, a known dry cleaning or wet cleaning may be used.

In the bonding step, the thin film transistor forming surface of the laminate with an attached TFT and the color filter forming surface of the laminate with an attached CF are made to face each other and bonding is performed by using a sealing agent (for example, an ultraviolet curable sealing agent for cell formation). Thereafter, a liquid crystal material is injected into the cell formed by the laminate with an attached TFT and the laminate with an attached CF. Examples of a method for injecting the liquid crystal material include a reduced pressure injection method and a dropping injection method.

### (Separation Step)

As illustrated in (D) of FIG. 2, the separation step is a step in which the laminate 24 with an attached member for an electronic device obtained in the member forming step is separated into the glass substrate 16 (glass substrate with an attached member) laminated with the member for an electronic device 22 and the adhesive layer 14 and the support substrate 12 with the interface between the adhesive layer 14 and the glass substrate 16 as a peeling surface to obtain an electronic device 26 including the member for an electronic device 22 and the glass substrate 16.

In a case where the member for an electronic device 22 on the glass substrate 16 at the time of peeling is only a part for forming all of the necessary constituent members, it is also possible to form the remaining constituent members on the glass substrate 16 after the separation.

The method for peeling off the electronic device 26 and the support substrate 18 with an attached adhesive layer is not particularly limited. Specifically, for example, it is possible to carry out the peeling by inserting a sharp blade like object into the interface between the glass substrate 16 and the adhesive layer 14 to give a trigger of peeling, and blowing a mixed fluid of water and compressed air thereon.

Preferably, the laminate 24 with an attached member for an electronic device is set on a platen so that the support substrate 12 is on the upper side and the member for an electronic device 22 side is on the lower side, the member for an electronic device 22 side is vacuum adsorbed on the platen (carried out sequentially in a case where the support substrates are laminated on both surfaces), and, in this state, a blade is first inserted into the interface between the glass substrate 16 and the adhesive layer 14. Thereafter, the support substrate 12 side is adsorbed by a plurality of vacuum adsorption pads, and the vacuum adsorption pads are raised in order from the vicinity of the place where the blade is inserted. Accordingly, an air layer is formed at the interface between the adhesive layer 14 and the glass substrate 16, the air layer spreads over the entire interface, and it is possible to easily peel off the support substrate 18 with an attached adhesive layer.

In addition, the support substrate 18 with an attached adhesive layer may be laminated with a new glass substrate to manufacture the glass laminate 10 of the present invention.

When peeling off the electronic device 26 from the support substrate 18 with an attached adhesive layer, it is preferable to carry out the peeling while blowing a peeling assistant into the interface between the glass substrate 16 and the adhesive layer 14. The peeling assistant is intended to mean a solvent such as water described above. Examples of the peeling assistant to be used include water, an organic solvent (for example, ethanol), and the like, mixtures thereof, and the like.

Here, when separating the electronic device 26 from the laminate 24 with an attached member for an electronic device, it is possible to further suppress electrostatic attraction of fragments of the adhesive layer 14 to the electronic device 26 by spraying with an ionizer and controlling the humidity.

The method for manufacturing the electronic device 26 described above is suitable for manufacturing a compact display device used for a mobile terminal such as a mobile phone or a PDA. The display device is mainly an LCD or OLED, and includes, as the LCD, TN-type, STN-type, FE-type, TFT-type, MIM-type, IPS-type, VA-type, and the like. Basically, it can be applied to display devices which are either passive drive-type or active drive-type.

Examples of the electronic device 26 manufactured by the above method include a panel for a display device having a glass substrate and a member for a display device, a photovoltaic cell having a glass substrate and a member for a photovoltaic cell, a thin film secondary battery having a glass substrate and a member for a thin film secondary battery, an electronic component having a glass substrate and a member for an electronic device, and the like. Panels for a display device include liquid crystal panels, organic EL panels, plasma display panels, field emission panels, and the like.

In the above description, the aspect using the glass laminate 10 was described in detail; however, it is also possible to manufacture the electronic device by using the glass laminate 100 according to the same procedure as above.

In a case of using the glass laminate 100, in the separation step described above, it is separated into the support substrate 12 and an electronic device including the adhesive layer 14, the glass substrate 16 and the member for an electronic device 22, with the interface between the support substrate 12 and the adhesive layer 14 as a peeling surface.

A specific description will be given below of the present invention with reference to examples and the like, but the present invention is not limited by these examples.

### EXAMPLES

In the following Examples 1 to 3 and Comparative Examples 1 and 2, as the glass substrate, a thin glass substrate (AN100 manufactured by Asahi Glass Co., Ltd.) was used having a length of 400 mm, a width of 300 mm, a thickness of 0.1 mm, and a linear expansion coefficient of 38×10⁻⁷/° C. In addition, as the support substrate, a glass substrate (AN100 manufactured by Asahi Glass Co., Ltd.) was used having a length of 400 mm, a width of 300 mm, a thickness of 0.5 mm, and a linear expansion coefficient of 38×10⁻⁷/° C. The glass substrate above was used in Example 4 and the support substrate above was used in Example 5.

### Example 1

First, each end surface of the support substrate was chamfered by using a #500 diamond wheel manufactured by Kure Grinding Wheel. Next, the surface of the support substrate was cleaned by cleaning with pure water using a brush, and then in a clean room (cleanliness: class 1000), a mixture of 100 parts by mass of a solventless addition reaction-type silicone for release paper (KNS-320A manufactured by Shin-Etsu Chemical Co., Ltd.) and 2 parts by mass of a platinum-based catalyst (CAT-PL-56 manufactured by Shin-Etsu Chemical Co., Ltd.) was coated (coating amount: 15 g/m²) by screen printing onto the cleaned support substrate surface, followed by curing by heating at 100° C. for 3 minutes to form a silicone resin layer having a film thickness of 15 μm.

Next, the surface of the glass substrate on the side to be in contact with the silicone resin layer was cleaned by pure water cleaning using a brush, and then the silicone resin layer on the support substrate and the glass substrate were bonded together by a vacuum press at room temperature to obtain a glass laminate.

### Example 2

First, nitrogen gas was blown onto the surface of the support substrate to remove dust and the like on the surface for adhesion, and then the support substrate was immersed in cleaning solutions in the order of 1: neutral detergent, 2: pure water, 3: isopropyl alcohol, and 4: acetone and subjected to ultrasonic cleaning for one minute each and four times each. After ultrasonic cleaning, nitrogen gas was blown onto the surface of the support substrate to carry out drying and then heating and drying were carried out at 50° C. under reduced pressure (0.5 kPa) in order to completely remove moisture.

Next, in a clean room (cleanliness: class 1000), a mixture of 100 parts by mass of a solventless addition reaction-type silicone for release paper (KNS-320A manufactured by Shin-Etsu Chemical Co., Ltd.) and 2 parts by mass of a platinum-based catalyst (CAT-PL-56 manufactured by Shin-Etsu Chemical Co., Ltd.) was coated (coating amount 15 g/m²) on the surface of the support substrate by screen printing, followed by curing by heating at 100° C. for 3 minutes to form a silicone resin layer having a film thickness of 15 μm.

Next, nitrogen gas was blown onto the surface of the side of the glass substrate to be in contact with the silicone resin layer to remove dust and the like on the surface for adhesion, followed by immersing in cleaning solutions in the order of 1: neutral detergent, 2: pure water, 3: isopropyl alcohol, and 4: acetone and subjecting to ultrasonic cleaning for one minute each and four times each. After ultrasonic cleaning, nitrogen gas was blown onto the surface of the glass substrate to carry out drying and then heating and drying were carried out at 50° C. under reduced pressure (0.5 kPa) in order to completely remove moisture.

Next, the silicone resin layer on the support substrate and the glass substrate were bonded together by a vacuum press at room temperature to obtain a glass laminate.

### Example 3

A glass laminate was obtained according to the same procedure as in Example 2 except that, when bonding the silicone resin layer and the glass substrate, the bonding was carried out while heating the silicone resin layer by a vacuum press at 150° C.

### Example 4

A glass laminate was obtained according to the same procedure as in Example 1 except that the following glass substrate was used as the support substrate.

As the support substrate, a glass substrate (AN100 manufactured by Asahi Glass Co., Ltd., length 400 mm, width 300 mm, thickness 0.5 mm) was used, which, after forming a glass into a plate shape by the float process, was contact packaged by using composite paper using 100% virgin pulp as a material pulp at the time of transport up to the pure water washing using a brush. More specifically, at the time of the contact packaging, a glass sheet packaging in which a plurality of glass substrates were laminated via the composite paper was formed, the glass sheet packaging was transported up to a predetermined place, and the glass substrate was taken out from the glass sheet packaging and used.

### Example 5

A glass laminate was obtained according to the same procedure as in Example 1 except that the following glass substrate was used as a glass substrate.

As the glass substrate, a glass substrate (AN100 manufactured by Asahi Glass Co., Ltd., length 400 mm, width 300 mm, thickness 0.1 mm) was used, which, after forming a glass into a plate shape by the float process, was contact packaged by using composite paper using 100% virgin pulp as a material pulp at the time of transport up to the pure water washing using a brush. More specifically, at the time of the contact packaging, a glass sheet packaging in which a plurality of glass substrates were laminated via the composite paper was formed, the glass sheet packaging was transported up to a predetermined place, and the glass substrate was taken out from the glass sheet packaging and used.

### Example 6

A glass laminate was obtained according to the same procedure as in Example 4 except that the following glass substrate was used as a glass substrate.

As the glass substrate, a glass substrate (AN100 manufactured by Asahi Glass Co., Ltd., length 400 mm, width 300 mm, thickness 0.1 mm) was used, which, after forming a glass into a plate shape by the float process, was contact packaged by using composite paper using 100% virgin pulp as a material pulp at the time of transport up to the pure water washing using a brush. More specifically, at the time of the contact packaging, a glass sheet packaging in which a plurality of glass substrates were laminated via the composite paper was formed, the glass sheet packaging was transported up to a predetermined place, and the glass substrate was taken out from the glass sheet packaging and used.

### Comparative Example 1

A glass laminate was obtained according to the same procedure as in Example 1 except that the cleanliness of the clean room was changed from class 1000 to class 10000.

In the manufacturing procedure of Comparative Example 1, the Requirement 2 described above is not satisfied.

### Comparative Example 2

A glass laminate was obtained according to the same procedure as in Example 1 except that the support substrate was not chamfered.

In the manufacturing procedure of Comparative Example 2, the Requirement 1 described above is not satisfied.

In each of the glass laminates manufactured in Examples and Comparative Examples, the peel strength between the support substrate and the silicone resin layer was larger than the peel strength between the silicone resin layer and the glass substrate.

In addition, in each of the glass laminates manufactured in Examples and Comparative Examples, both the contact area between the silicone resin layer and the support substrate and the contact area between the silicone resin layer and the glass substrate were 1200 cm².

### (Bubble Evaluation)

In each of the glass laminates manufactured in Examples and Comparative Examples, bubbles generated between the silicone resin layer and the glass substrate were observed. Specifically, in the observation region (the entire surface of the glass substrate) between the silicone resin layer and the glass substrate, the presence or absence of bubbles and the diameter of the bubbles were observed by visual observation from the normal direction of the glass substrate. As described above, the diameter of the bubbles corresponds to the circle equivalent diameter.

The results are shown collectively in Table 1.

### (Peeling Test)

100 glass laminates manufactured in Examples and Comparative Examples were prepared and each was heated at 300° C. for 1 hour and then subjected to a peeling test to evaluate whether or not cracking defects occurred in the substrate due to bubbles.

In the peeling test, the laminates were placed on a fixing base so that the glass substrate was on the lower side and fixed by vacuum adsorption, and, in order to peel off the support substrate in this state, a trigger of peeling was given with a razor blade at the end portion and an upward force was applied to the support substrate to thereby progress the peeling between the silicone resin layer and the glass substrate, and the support substrate was separated from the glass substrate.

In the evaluation of the peeling, evaluation was performed in three grades of “A”, “B”, and “C”, in which “A” means that it was possible to peel the glass substrate without cracking on 98 or more of the glass laminates, “B” means that it was possible to peel the glass substrate without cracking on 95 or more and 97 or less of the glass laminates, and “C” means that it was possible to peel the glass substrate without cracking on 94 or less of the glass laminates.

TABLE 1

| | | Peeling Test |
|---|---|---|
| | Bubble diameter | Result |
| Example 1 | 8 to 10 mm | B |
| Example 2 | 8 to 10 mm | B |
| Example 3 | 2 to 4 mm | A |
| Example 4 | 2 to 4 mm | A |
| Example 5 | 3 to 5 mm | A |
| Example 6 | 1 to 3 mm | A |
| Comparative | 12 to 15 mm | C |
| Example 1 | | |
| Comparative | 15 to 18 mm | C |
| Example 2 | | |

According to the above table, in Comparative Examples 1 and 2 in which the bubble diameter (diameter of bubbles) was 12 to 18 mm, it was confirmed that the peeling yield was decreased and problems occurred.

On the other hand, in Examples 1 to 6 in which the bubble diameter was 10 mm or less, it was confirmed that it was possible to manufacture a glass laminate exhibiting a high peeling yield. In particular, in Examples 3 to 6 in which the bubble diameter was 5 mm or less, it was confirmed that an extremely high peeling yield was exhibited.

### Example 7

In this example, an OLED is manufactured by using the glass laminate obtained in Example 1.

First, on the second main surface of the glass substrate of the glass laminate, silicon nitride, silicon oxide and amorphous silicon are formed into a film in this order by a plasma CVD method. Next, low concentration boron is injected into the amorphous silicon layer by an ion doping device, and heat treatment is performed in a nitrogen atmosphere at 450° C. for 60 minutes to perform a dehydrogenation treatment.

Next, a crystallization treatment of the amorphous silicon layer is performed by a laser annealing device. Next, low concentration phosphorus is injected into the amorphous silicon layer by an etching using the photolithography method and ion doping device to form N-type and P-type TFT areas. Next, a silicon oxide film is formed on the second main surface side of the glass substrate by a plasma CVD method to form a gate insulating film, and then molybdenum is formed into a film by a sputtering method, and a gate electrode is formed by etching using a photolithography method.

Next, high concentration boron and phosphorus are injected into each of the desired areas of N-type and P-type by a photolithography method and an ion doping device to form a source area and a drain area. Next, on the second main surface side of the glass substrate, an interlayer insulating film is formed by forming a film of silicon oxide by the plasma CVD method, and a TFT electrode is formed by forming a film of aluminum by a sputtering method and etching using a photolithography method.

Next, a heat treatment is performed in a hydrogen atmosphere at 450° C. for 60 minutes to perform a hydrogenation treatment, and then a passivation layer is formed by forming a film of nitrogen silicon by the plasma CVD method. Next, an ultraviolet curable resin is coated on the second main surface side of the glass substrate, and a planarization layer and a contact hole are formed by the photolithography method. Next, indium tin oxide is formed into a film by a sputtering method and a pixel electrode is formed by etching using the photolithography method.

Subsequently, on the second main surface side of the glass substrate, in this order and using a deposition method, 4,4′,4″-tris(3-methylphenylphenylamino) triphenylamine as a hole injection layer, bis[(N-naphthyl)-N-phenyl] benzidine as a hole transporting layer, a mixture of 2,6-bis[4-[N-(4-methoxyphenyl)-N-phenyl]aminostyryl]naphthalene-1,5-dicarbonitrile (BSN-BCN) at 40% by volume in an 8-quinolinol aluminum complex (Alq₃) as a light emitting layer, and Alq₃ as an electron transporting layer are formed. Next, an aluminum is formed into a film by a sputtering method and a counter electrode is formed by etching using the photolithography method. Next, another glass substrate is bonded to the second main surface side of the glass substrate via an ultraviolet-curable adhesive layer and sealed. By the above procedure, the organic EL structure is formed on the glass substrate. A glass laminate (referred to below as panel A) having an organic EL structure on a glass substrate is the laminate with an attached member for an electronic device of the present invention (a panel for a display device with a support substrate).

Subsequently, the sealing body side of the panel A is vacuum-adsorbed on a platen, a stainless-steel blade having a thickness of 0.1 mm was inserted into the interface between the glass substrate and the silicone resin layer at the corner of the panel A, and a trigger of peeling is given at the interface between the glass substrate and the silicone resin layer. Then, the surface of the support substrate of panel A is adsorbed by the vacuum adsorption pad, and the adsorption pad is raised. Here, the insertion of the blade is carried out while spraying static eliminating fluid from an ionizer (manufactured by Keyence Corporation) onto the interface. Next, the vacuum adsorption pad is pulled up while continuously spraying the static eliminating fluid from the ionizer toward the formed gap. As a result, only the glass substrate on which the organic EL structure is formed is left on the platen, and it is possible to peel off the support substrate with an attached silicone resin layer.

Subsequently, the separated glass substrate is cut by using a laser cutter or a scribe-break method and divided into a plurality of cells, and then the glass substrate on which the organic EL structure is formed and the counter substrate are assembled to carry out a module forming step to form an OLED. The OLED obtained in this manner has no problems in terms of characteristics.

### INDUSTRIAL APPLICABILITY

The glass laminate according to the present invention is suitable for manufacturing a photovoltaic cell, a liquid crystal display panel, an organic EL panel, other thin display device panels, and the like.

While the present invention has been described in detail and with reference to specific embodiments thereof, it will be apparent to one skilled in the art that various changes and modifications can be made therein without departing from the intention and scope of the present invention. The present application is based on a Japanese patent application filed on Dec. 26, 2014 (Application No. 2014-265172) and a Japanese patent application filed on Nov. 2, 2015 (Application No. 2015-215819), the whole thereof being incorporated herein by reference.

### REFERENCE SIGNS LIST

10, 100 GLASS LAMINATE

12 SUPPORT SUBSTRATE

14 ADHESIVE LAYER

16 GLASS SUBSTRATE

18 SUPPORT SUBSTRATE WITH ATTACHED ADHESIVE LAYER

20 GLASS SUBSTRATE WITH ATTACHED ADHESIVE LAYER

22 MEMBER FOR ELECTRONIC DEVICE

24 LAMINATE WITH ATTACHED MEMBER FOR ELECTRONIC DEVICE

26 ELECTRONIC DEVICE

1. A glass laminate comprising a support substrate, an adhesive layer and a glass substrate in this order, and having a peel strength between the support substrate and the adhesive layer different from a peel strength between the adhesive layer and the glass substrate, wherein:
the glass laminate has a contact area between the adhesive layer and the support substrate and a contact area between the adhesive layer and the glass substrate both being 1200 cm² or more;
the glass substrate has a thickness of 0.3 mm or less; and
there are no bubbles or, when there is a bubble(s), the bubble(s) has a diameter of 10 mm or less, in a boundary between the support substrate and the adhesive layer or a boundary between the adhesive layer and the glass substrate, whichever has a smaller peel strength.

2. The glass laminate according to claim 1, wherein the diameter of the bubble(s) is 5 mm or less.

3. The glass laminate according to claim 1, wherein the support substrate is a glass sheet.

4. The glass laminate according to claim 1, wherein the adhesive layer is a silicone resin layer or a polyimide resin layer.

5. The glass laminate according to claim 1, wherein the peel strength between the support substrate and the adhesive layer is larger than the peel strength between the adhesive layer and the glass substrate.

6. A method for manufacturing an electronic device, comprising:
a member forming step of forming a member for an electronic device on a surface of the glass substrate of the glass laminate described in claim 5 to obtain a laminate with an attached member for an electronic device; and
a separation step of removing a support substrate with an attached adhesive layer comprising the support substrate and the adhesive layer from the laminate with an attached member for an electronic device to obtain an electronic device comprising the glass substrate and the member for an electronic device.

7. A method for manufacturing the glass laminate described in claim 1,
wherein a glass sheet in a glass sheet packaging, in which a plurality of glass sheets are laminated via a composite paper(s) made of a virgin pulp, is used as at least one of the support substrate and the glass substrate of the glass laminate to manufacture the glass laminate.

8. A glass sheet packaging comprising a plurality of glass sheets laminated via a composite paper(s) made of a virgin pulp, and used for manufacturing a glass laminate comprising a support substrate, an adhesive layer and a glass substrate in this order.
